(19) United States
(12) Patent Application Publication
(10) Pub. No.: US 2004/0039576 A1
(43) Pub. Date: Feb. 26, 2004

(54) Sales data exchange system and method

(76) Inventors: ZhiGang He, Shenzhen (CN); Simon Shen, Shenzhen (CN); Michael Hsu, Shenzhen (CN); TangHao Chu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/172,631

(22) Filed: Jun. 13, 2002

(51) Int. Cl. G06F 17/60

(52) U.S. Cl. 705/1; 705/28; 705/10

(57) ABSTRACT

A sales data exchange system and method for exchanging data with customers and suppliers by integrating data in an internal information system and EDI data received. The sales data exchange system (1) includes a main database (16) for storing sales data; an EDI data translator (14) for converting a format of the sales data; an EDI data input and output device (13) for sending and receiving the sales data in EDI format; and a plurality of user clients (11) provided for users to send and receive EDI data. Each of the user clients includes a sales order control unit (12) for handling the sales data, the sales order control unit including an order management module (120) for managing sales orders data, a shipping management module (122) for managing shipping data, and an invoice management module (124) for managing invoice data, and an inventory management module (126).

### BACKGROUND OF THE INVENTION

1. Field of the Invention

This invention relates to systems and methods for exchanging sales data, and more particularly to systems and methods which can integrate data in an internal information system with electronic data interchange (EDI) data received.

2. Description of Related Art

With recent advances in communications technology, traditional methods of data interchange between enterprises are gradually being replaced by the use of electronic data such as EDI and web technology. More and more enterprises are adopting such electronic data to improve their working efficiency and cut down operating costs. One important field concerned is the transmission of purchase and sales order data and cargo shipment data, which are conventionally transmitted by post or fax. Generally, a customer sends purchase order data having a standard EDI format to a supplier. The supplier then schedules production and shipping according to the purchase order data. When the cargo required by the purchase order is manufactured and ready, the supplier sends an EDI message about shipping information to the customer. The customer then collects the cargo at a designated time.

Cargo delivery from the supplier to the customer is invariably handled by a carrier. The carrier may be an independent transportation company, or a shipping department of the supplier or of the customer. A carrier generally has a warehouse located relatively near the customer's premises. Some carriers provide temporarily storage of cargo, and subsequent delivery once the customer requires the cargo. The carrier needs to be involved in the cargo delivery data interchange between the supplier and the customer.

In addition, although many enterprises have an independent EDI system for interchanging data with their suppliers and customers, few enterprises integrate their EDI system with their internal management information system (MIS). As a result, scheduling of production and shipping according to current inventory and customers' orders is inconvenient and inefficient.

Accordingly, what is needed is a system and method which can overcome the abovementioned problems.

### SUMMARY OF THE INVENTION

A primary object of the present invention is to provide a system which can integrate data in an internal information system with EDI data received, for efficient scheduling of production and shipment.

Another object of the present invention is to provide a method which can integrate data in an internal information system with EDI data received, for efficient scheduling of production and shipment.

To achieve the aforesaid primary object, in one aspect of the present invention, a sales data exchange system comprises: a main database for storing sales data; an EDI data translator electronically connected with the main database for converting a format of the sales data; an EDI data input and output device electronically connected with the EDI data translator for sending and receiving the sales data in EDI format; and a plurality of user clients electronically connected with the main database for users to send and receive EDI data. Each of the user clients comprises a sales order control unit for handling the sales data. Each sales order control unit comprises an order management module for managing sales order data stored in the main database, a shipping management module for managing shipping data relating to sales orders, an invoice management module for managing invoice data relating to sales orders, and an inventory management module for users to search for data on inventory.

To achieve the aforesaid other object, in another aspect of the present invention, a sales data exchange method comprises the following steps: receiving EDI data on a shipping requirement from a customer via an EDI value added network; translating the EDI data on the shipping requirement into standard data which can be stored in a standard relational database; retrieving inventory data according to the data on the shipping requirement from a main database which is connected with an internal management information system; arranging and sending a shipping schedule to the customer according to the data on the shipping requirement and the inventory data; sending the shipping schedule to a carrier that is in charge of dispatching cargo required by the customer; receiving cargo pick-up information sent by the carrier; receiving cargo drop-off information sent by the carrier; receiving sales confirmation information sent by the customer; and sending invoice information to the customer according to the data on the shipping requirement.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is a schematic diagram of a framework of a sales data exchange system according to a preferred embodiment of the present invention, together with a carrier MIS, a customer MIS, an EDI value-added network (VAN) and an internal MIS;

FIG. 2 is a schematic diagram of a framework of a sales order control unit installed in a user client of the system of FIG. 1;

FIG. 3 is a flowchart showing data exchange of the system of FIG. 1;

FIG. 4 is a flowchart of processing of data received by the system of FIG. 1 from the customer MIS or the carrier MIS, according to the preferred embodiment of the present invention; and

FIG. 5 is a flowchart of sending of data from the system of FIG. 1 to the customer MIS and the carrier MIS, according to the preferred embodiment of the present invention.

### DETAILED DESCRIPTION OF THE INVENTION

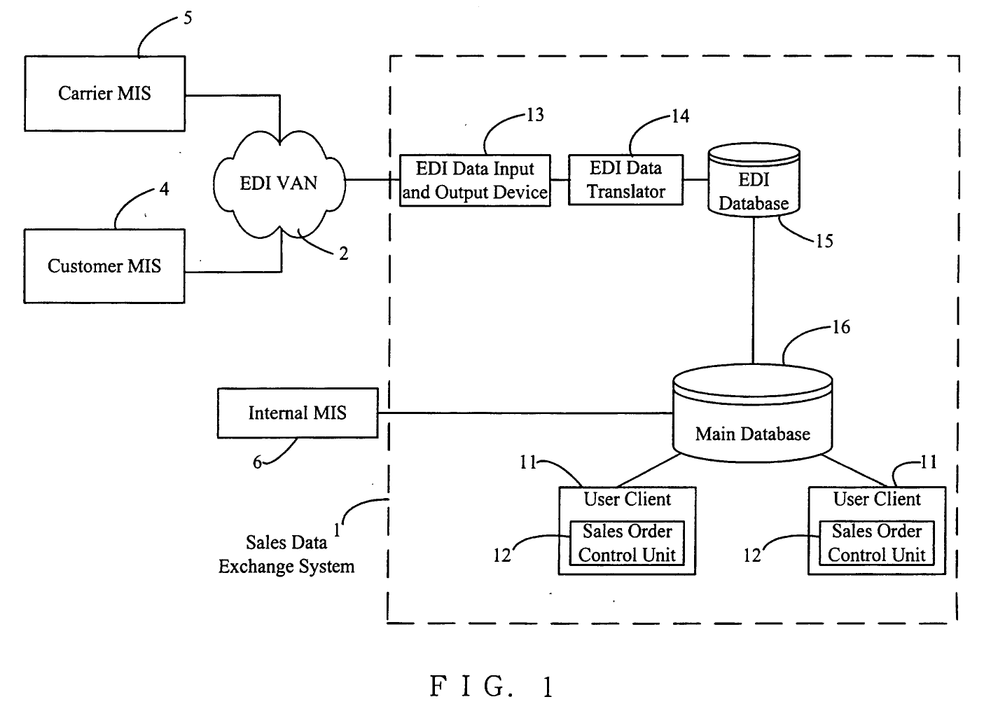

FIG. 1 is a schematic diagram of a framework of a sales data exchange system 1 according to a preferred embodiment of the present invention. The sales data exchange system 1 comprises a plurality of user clients 11, an electronic data interchange (EDI) data input and output device 13, an EDI data translator 14, an EDI database 15, and a main database 16. An internal management information system (MIS) 6 is electronically connected with the main database 15 for providing required data to the main database 16. The internal MIS 6 can be an information system which includes data about procurement, production and sales of a factory. The main database 16 is provided for storing data related to the factory as well as data related to its customers and suppliers. The EDI database 15 is a relational database, and is provided for temporarily storing data that are received from or sent to an external system. The EDI data translator 14 provides the function of inter-converting between a format of EDI data and a format of the data stored in the relational database. The EDI input and output device 13 is provided for sending EDI data to or receiving EDI data from an EDI value-added network (VAN) 2. A plurality of customer MISs 4 (only one shown) and carrier MISs 5 (only one shown) can interchange EDI data with the sales data exchange system 1 via the VAN 2. The carrier MIS 5 is implemented in a carrier organization. The carrier organization may be an independent company, or a shipping department of the factory. The carrier organization's premises are preferably located relatively near the customers' premises, and are for helping the factory to transport manufactured cargo to the customers.

The user clients 11 are provided for searching and managing the data stored in the main database 16. Each user client 11 comprises a sales order control unit 12 for controlling all activities related to performance of a sales order. An authorized user can electronically visit the main database 16 and send relevant requirements regarding performance of a sales order via the sales order control unit 12.

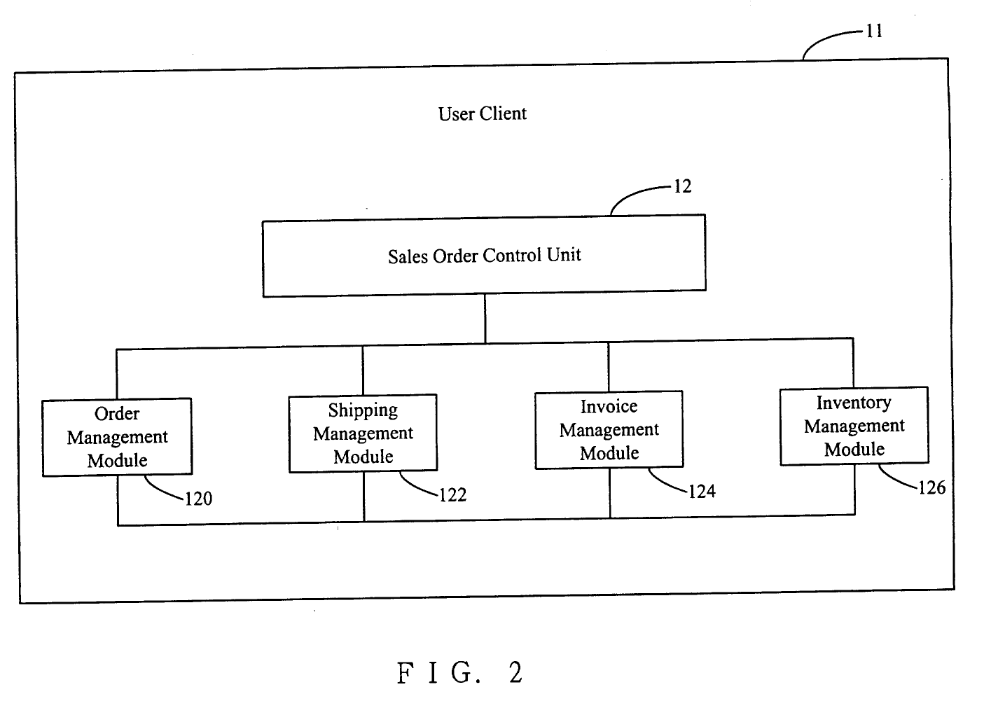

FIG. 2 is a schematic diagram of a framework of the sales order control unit 12 installed in each user client 11 of the sales data exchange system 1. The sales order control unit 12 comprises an order management module 120 for managing sales orders sent by customers, a shipping management module 122 for managing delivery of cargo specified in the sales orders, an invoice management module 124 for managing invoices required for performance of the sales orders, and an inventory management module 126 for managing inventory data. The order management module 120 provides users the functions of searching for sales orders sent by customers, and calculating total raw materials and production capability required. The shipping management module 122 is provided for users to search for a shipping status of cargo specified in a sales order. If authorized, a user can send a shipping advice to or receive a receipt of cargo from the customer via the shipping management module 122. The invoice management module 124 is provided for users to search for an invoicing status of a sales order, and to set up a new invoice for the sales order. The inventory management module 126 is provided for users to search for data on inventory.

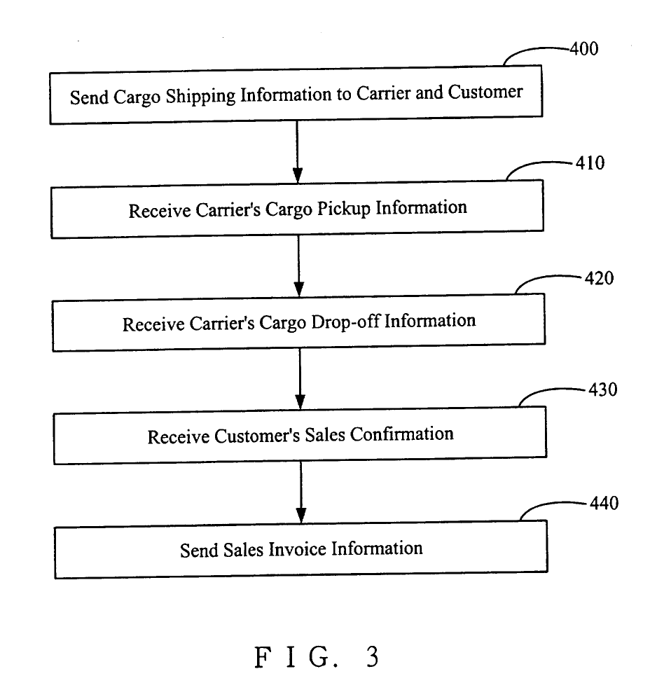

FIG. 3 is a flowchart showing data exchange of the sales data exchange system 1. In step 400, a user sends cargo shipping information to the carrier and the customer via the sales data exchange system 1, according to shipping dates required by the sales orders. The cargo shipping information is for notifying the carrier and the customer of the cargo's shipping status. The cargo's shipping status includes shipping date, arrival date, and cargo information listed in the relevant sales order. In step 410, when the carrier receives the cargo, the carrier sends out cargo pickup information. The cargo pickup information is received by the sales data exchange system 1 via the EDI VAN 2. Generally, the cargo pickup information is also sent to the customer, for determination of a specific time of dispatch from the carrier to the customer. After the carrier dispatches the cargo to the customer, in step 420, the carrier drops off the cargo at the customer's premises, whereupon the carrier sends out cargo drop-off information. The cargo drop-off information is received by the sales data exchange system 1 via the EDI VAN 2. In step 430, after receiving the dropped-off cargo, the customer sends sales confirmation data to the factory via the EDI VAN 2. In step 440, the user sends sales invoice information to the customer for payment for the cargo.

Generally, a specific kind of information is transmitted in a specific EDI data format. For example, the sales confirmation data sent by the customer are transmitted in an EDI 856 format. This is a standard EDI format for transmitting a sales confirmation message. In response to the EDI 856, the user sends an EDI 810 format invoice message. This is a standard EDI format for an invoice message.

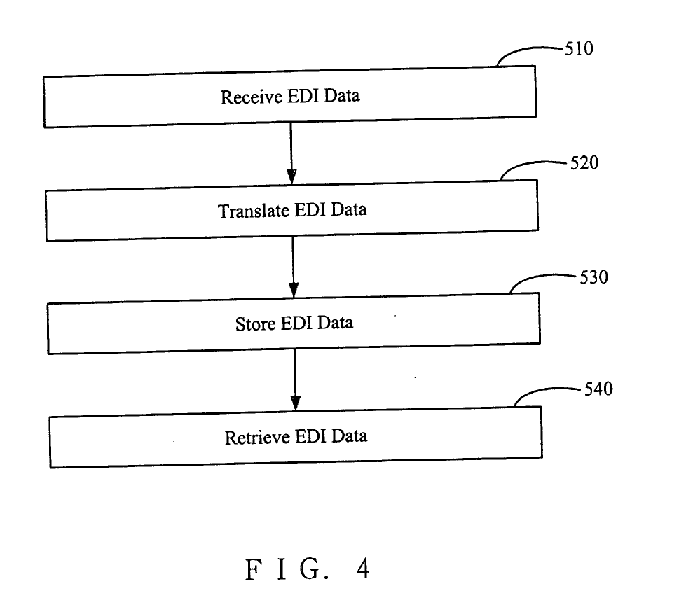

FIG. 4 is a flowchart of processing of data received by the sales data exchange system 1 from any customer MIS 4 or any carrier MIS 5, according to the preferred embodiment of the present invention. In step 510, the EDI data input and output device 13 receives EDI data sent from the customer or the carrier via the EDI VAN 2. The EDI data comprise a carrier's pick-up advice message in EDI 861-38 format, a carrier's drop-off advice message in EDI 861-54 format, and a customer's sales confirmation message in EDI 856 format. In step 520, the EDI data translator 14 automatically translates the received EDI data into data having a standard format of the relational database. In step 530, the translated EDI data are transmitted to and temporarily stored in the EDI database 15. In step 540, the translated EDI data are retrieved and transmitted to the main database 16. Authorized users can view the content of and retrieve the translated EDI data in the main database 16 via any user client 11.

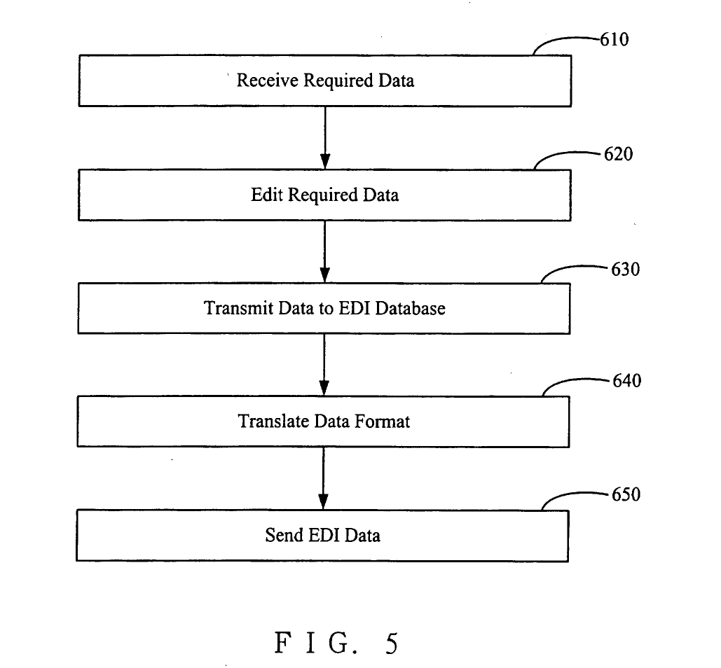

FIG. 5 is a flowchart of sending of data from the sales data exchange system 1 to any customer MIS 4 and any carrier MIS 5, according to the preferred embodiment of the present invention. In step 610, the data required to be sent to the customer or the carrier are received from the internal MIS 6 and stored in the main database 16. In step 620, an authorized user edits the required data stored in the main database 16 via the sales order control unit 12 of the user client 11. In step 630, the required data are transmitted to and temporarily stored in the EDI database 15, which then transmits them to the EDI data translator 14. In step 640, the EDI data translator 14 translates the data into standard EDI format. In step 650, the EDI data are sent out by the EDI data input and output device 13 via the EDI VAN 2.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A sales data exchange system, comprising:
a main database for storing sales data;
an EDI data translator electronically connected with the main database for converting a format of the sales data;
an EDI data input and output device electronically connected with the EDI data translator for sending and receiving the sales data in EDI format; and
a plurality of user clients electronically connected with the main database, each of the user clients comprising a sales order control unit for handling the sales data, wherein the sales order control unit comprises an order management module for managing sales order data stored in the main database, a shipping management module for managing shipping data relating to sales orders, and an invoice management module for managing invoice data relating to sales orders.

2. The system as claimed in claim 1, further comprising an EDI database electronically connected with the main database for receiving and temporarily storing the sales data.

3. The system as claimed in claim 1, wherein the sales order control unit further comprises an inventory management module for searching for inventory data stored in the main database.

4. The system as claimed in claim 1, wherein the main database electronically connects with an internal management information system and receives sales order data therefrom.

5. The system as claimed in claim 1, wherein the EDI data input and output device is electronically connected with an EDI value added network, whereby the EDI data input and output device can interchange data with suppliers and customers via the EDI value added network.

6. A sales data exchange method, comprising the following steps:
receiving EDI data on shipping requirements from a customer via an EDI value added network;
translating the EDI data on shipping requirements into standard data which can be stored in a standard relational database;
retrieving inventory data according to the data on shipping requirements from a main database which is connected with an internal management information system; and
arranging and sending a shipping schedule to the customer according to the data on shipping requirements and the inventory data.

7. The method as claimed in claim 6, further comprising the step of:
sending the shipping schedule to a carrier which is in charge of dispatching cargo required by the customer.

8. The method as claimed in claim 6, further comprising the step of:
receiving cargo pick-up information sent by the carrier.

9. The method as claimed in claim 6, further comprising the step of:
receiving cargo drop-off information sent by the carrier.

10. The method as claimed in claim 6, further comprising the step of:
receiving sales confirmation information sent by the customer.

11. The method as claimed in claim 6, further comprising the step of:
sending invoice information to the customer according to the data on shipping requirements.

12. A sales data exchange method, comprising the following steps:
receiving EDI data on a shipping requirement from a customer via an EDI value added network;
translating the EDI data on the shipping requirement into standard data which can be stored in a standard relational database;
retrieving inventory data according to the data on the shipping requirement from a main database which is connected with an internal management information system;
arranging and sending a shipping schedule to the customer according to the data on the shipping requirement and the inventory data;
sending the shipping schedule to a carrier that is in charge of dispatching cargo required by the customer;
receiving cargo pickup information sent by the carrier;
receiving cargo drop-off information sent by the carrier;
receiving sales confirmation information sent by the customer, and
sending invoice information to the customer according to the data on the shipping requirement.
